(19) United States
(12) Patent Application Publication
(10) Pub. No.: US 2005/0212269 A1
(43) Pub. Date: Sep. 29, 2005

(54) Thin airbag module

(76) Inventor: David W. Schneider, Waterford, MI (US)

Correspondence Address: Sally J. Brown;AUTOLIV ASP, INC., 3350 Airport Road, Ogden, UT, 84405, US

(21) Appl. No.: 10/807,730

(22) Filed: Mar. 24, 2004

(51) Int. Cl. B60R 21/20; B60R 21/16

(52) U.S. Cl. 280/728.3; 280/732

(57) ABSTRACT

An airbag module may have an inflator, a cushion, and a housing that contains the inflator and the cushion. The cushion is folded flat over a large area of an instrument panel so that the cushion inflates rapidly to protect out-of-position occupants. The housing retains the cushion and the inflator such that the inflator is positioned forward of the cushion. The housing may be deformable in response to impact to provide cushioning and/or provide a softer impact against the inflated cushion. A flat diffuser may be used to help convey inflation gas from the inflator to the cushion. The airbag module may have a thin membrane that hides the cushion from vehicle occupants. The cushion may tear through the membrane. A rigid tear initiation member may be positioned between the cushion and membrane to help the cushion break through the membrane.

### BACKGROUND OF THE INVENTION

The inclusion of inflatable safety restraint devices, or airbags, is now a legal requirement for many new vehicles. Airbags are typically installed in the steering wheel and in the dashboard on the passenger's side of a car. Additionally, airbags may be installed to inflate beside vehicle occupants to provide side impact protection, in front of the knees to protect the knees from impact, or at other strategic locations.

In the event of an accident, a sensor system within the vehicle senses an impact situation and triggers the ignition of an inflator. Inflation gases from the inflator fill the airbag cushions, which immediately inflate to protect the driver and/or passengers from impact against the interior surfaces of the vehicle. During normal vehicle operation, airbags are typically stowed behind covers to protect them from tampering and provide a more attractive interior facade for the vehicle.

Passenger side frontal impact airbags are often installed in the instrument panel of the vehicle. Often, such airbags are installed on an upper surface of the instrument panel. The inflator is installed within the instrument panel and is disposed such that inflation gas flows into the cushion to cause the cushion to expand upward and rearward. The folded cushion and the inflator are typically packaged within a housing that keeps the cushion folded and retains the inflator and cushion during deployment. The housing is typically formed of sheet metal or the like. The cushion is typically packed in such a manner that several folds are positioned on top of the inflator. The folds are all ejected from the housing during inflation, and the cushion inflates outward from the ejection trajectory to broaden the cushion surface contacted by the occupant.

Unfortunately, some vehicle occupants do not use their seat belts. Accordingly, it is possible that an occupant of a passenger's side, front seat will be “out-of-position.” Such an occupant may be close to or even resting on the instrument panel when a collision occurs, as in a pre-collision braking situation. The occupant may also be off-center from the position at which the cushion deploys. Thus, the time required for the cushion to inflate from the instrument panel may be too great for the cushion to provide effective impact protection for such an occupant.

### BRIEF SUMMARY OF THE INVENTION

The apparatus and method of the present invention have been developed in response to the present state of the art, and in particular, in response to the problems and needs in the art that have not yet been fully solved by currently available airbag modules. Thus, it is an overall objective of the present invention to provide an airbag module and associated methods that remedy the shortcomings of the prior art.

To achieve the foregoing objective, and in accordance with the invention as embodied and broadly described herein in one embodiment, an airbag module includes a cushion, an inflator, and a housing that generally contains the cushion and the inflator. A cover extends over the cushion, inflator, and housing to hide them from vehicle occupants. The inflator may be connected to an electronic control unit (ECU) that is further coupled to a collision sensor, such as an accelerometer, so that the ECU is able to transmit an activation signal to the inflator in response to detection of a collision by the collision sensor. The vehicle has a windshield and an instrument panel from which the cushion deploys.

The cushion is stowed in a compacted configuration within the instrument panel, in which the cushion has a small thickness perpendicular to a periphery of the instrument panel and is spread along a relatively broad portion of the periphery. Accordingly, the cushion requires a relatively low amount of energy to move from its compacted configuration to a fully inflated configuration. Additionally, the cushion provides a relatively broad impact surface even before inflation. Thus, if an occupant of the vehicles is out-of-position, there is still a relatively high likelihood that the cushion will be positioned to soften or prevent impact of the occupant with the instrument panel.

The housing has an inflator retention portion, to which the inflator is attached, and a cushion retention portion. The housing may be mounted to vehicle structures within the instrument panel, and may provide a relatively shallow compartment within which the cushion is folded. The housing may have a generally rigid structure, but may have a thickness and geometry selected such that the housing is able to deflect into the instrument panel in response to impact of the occupant against the cushion. Such deflection of the housing may provide additional cushioning.

The inflator may be of a type commonly used for driver's side airbag modules. The inflator may have a relatively short length along its axis, and may have a flange attached to the housing. The inflator may have an electrical connection portion coupled to the ECU and a gas ejection portion that extends through an opening in the housing and into an interior portion of the cushion. The folds of the cushion are positioned rearward of the inflator, so that the interior portion is separated from the cover by only a single layer of the fabric of which the cushion is formed and the center of the cushion is located rearward of the inflator.

The cover may be formed of a decorative plastic and/or foam like that used to form vehicle trim. The cover may have a fixed end fixedly attached to the housing and a removably fixed end that can separate from the housing when the cushion inflates. The removably fixed end may be attached to the housing via a frangible fastener such as a Christmas tree-type fastener or the like. The cover may also have a hinge portion that permits the cover to swing open proximate the fixed end.

After the inflator receives an activation signal, ejection gas is ejected into the interior portion of the cushion in which the gas ejection portion is disposed. The inflation gas causes the cushion to unfold and expand upward and rearward, toward the vehicle occupant. The frangible fastener breaks to release the removably fixed end, thereby permitting the cover to swing open to allow the cushion to escape from the instrument panel. The relatively broad area along which the cushion extends with respect to the periphery of the instrument panel serves to expedite inflation. As the occupant contacts and applies pressure against the cushion, the housing may deflect to provide additional cushioning. In the event that the occupant contacts the cover prior to inflation of the cushion, the housing may also deflect to provide cushioning against direct impact with the instrument panel.

According to one alternative embodiment of the invention, an airbag module may again include a cushion, an inflator, a housing, and a cover. Additionally, the airbag module includes a tear initiation member. In place of the housing of the previous embodiment, a two-piece housing may be used. The housing has a first piece that is generally planar and a second piece shaped to hold the inflator against the first piece.

The inflator may be an elongated inflator of a type commonly used in passenger's side airbag modules. The inflator may have a main body and a diffuser extending from proximate the middle of the main body. The diffuser extends through an opening in the first piece so that inflation gas ejected from the diffuser passes directly into an interior portion of the cushion. The inflator is positioned forward of the center of the cushion.

By contrast with the cover of the previous embodiment, the cover of this configuration may be formed of a relatively thin plastic and/or foam membrane. The membrane may be attached to the housing in such a manner that the membrane remains attached to the housing during inflation of the cushion. The tear initiation member is positioned between the cushion and the cover such that, when the cushion expands, the tear initiation member flexes outward to break through the membrane to form a tear. The membrane opens along the tear to permit the cushion to pass through the membrane, and into the passenger compartment.

According to another alternative embodiment of the invention, an airbag module once again has a cushion, an inflator, a housing, and a cover. The housing is shaped to form a diffuser with an inflator retention portion and a cushion retention portion. The inflator retention portion has an inflator containment wall with a generally cylindrical configuration. Inflator retention extensions extend inward from the inflator containment wall to hold the inflator in place. The cushion retention portion is generally planar and has a plurality of orifices through which inflation gas is able to escape the diffuser and flow into the cushion.

The inflator may be an elongated inflator with radial gas output. The inflation gas is able to flow outward from the inflator, and then into the cushion retention portion. The cushion is folded over the cushion retention portion, which is rearward of the inflator retention portion. Accordingly, as in the previous embodiments, the inflator is positioned generally forward of the center of the cushion.

The diffuser is positioned generally inside the cover, and the ends of the cover are fixedly attached to the underside of the diffuser. As in the previous embodiment, the cover takes the form of a thin membrane. The cover has a central portion in which a score is formed. After the inflator receives an activation signal, inflation gas flows from the inflator retention portion and into the cushion retention portion of the diffuser. From the cushion retention portion, inflation gas flows through the orifices and into the cushion. The cushion expands, rupturing the cover along the score. The cushion inflates through the resulting opening, and the membrane stretches as needed to permit passage of the cushion.

Through the use of airbag modules and associated methods of the present invention, airbag modules may provide rapid deployment over a comparatively large area. Thus, vehicle occupants may be more effectively protected from impact. Such airbag modules also provide enhanced protection for vehicle occupants who are out-of-position at the time of collision. Furthermore, the airbag module may be efficiently and cost-effectively manufactured. These and other features and advantages of the present invention will become more fully apparent from the following description and appended claims, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a side elevation view of an airbag module according to one-embodiment of the invention, mounted as a passenger side, frontal impact airbag within the instrument panel of a sectioned vehicle, with the cushion in the inflated configuration;

FIG. 2 is an enlarged, side elevation section view of the airbag module of FIG. 1, with the cushion in the compacted configuration;

FIG. 3 is a side elevation, section view of an airbag module according to one alternative embodiment of the invention, with the cushion in the compacted configuration; and

FIG. 4 is a side elevation, section view of an airbag module according to another alternative embodiment of the invention, with the cushion in the compacted configuration.

### DETAILED DESCRIPTION OF THE INVENTION

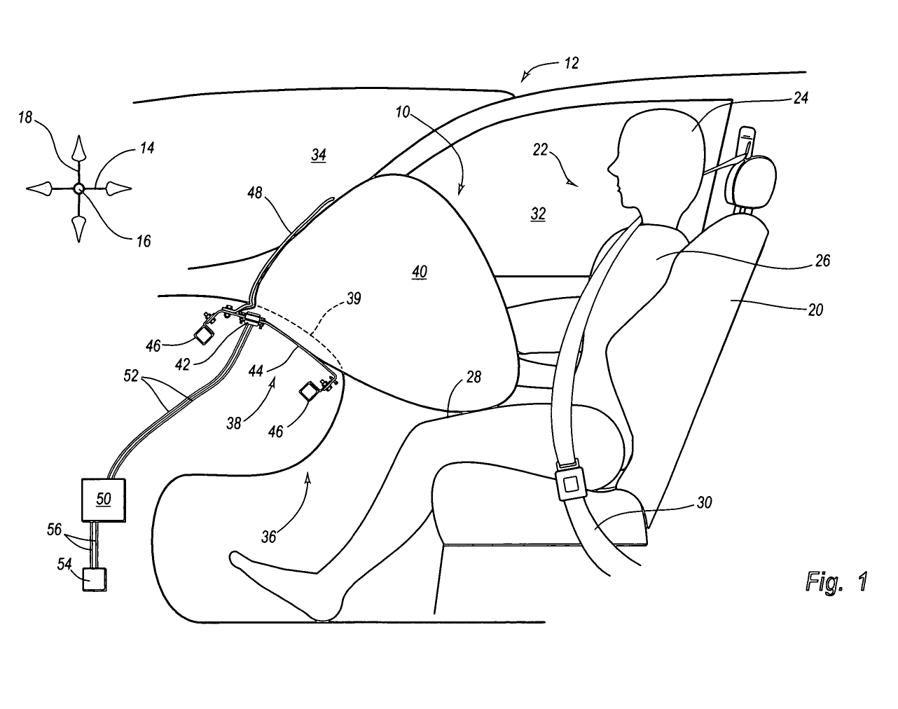

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 4, is not intended to limit the scope of the invention, as claimed, but is merely representative of presently preferred embodiments of the invention.

For this application, the phrases “connected to,” “coupled to,” and “in communication with” refer to any form of interaction between two or more entities, including mechanical, electrical, magnetic, electromagnetic, and thermal interaction. The phrase “attached to” refers to a form of mechanical coupling that restricts relative translation or rotation between the attached objects. The phrases “pivotally attached to” and “slidably attached to” refer to forms of mechanical coupling that permit relative rotation or relative translation, respectively, while restricting other relative motion.

The phrase “attached directly to” refers to a form of attachment by which the attached items are either in direct contact, or are only separated by a single fastener, adhesive, chemical bond, or other attachment mechanism. The term “abutting” refers to items that are in direct physical contact with each other, although the items may not be attached together. The term “grip” refers to items that are in direct physical contact with each other, wherein one item holds the other firmly. The terms “integrally formed” refer to a body that is manufactured integrally, i.e., as a single piece, without requiring the assembly of multiple pieces. Multiple parts may be integrally formed with each other if they are formed from a single workpiece. Items that are “coupled to” each other may be formed as a single piece with each other.

Referring to FIG. 1, a side elevation view shows an airbag module 10 according to one embodiment of the invention. The airbag module 10 is designed to provide passenger's side, frontal impact protection. However, those of skill in the art will recognize that the present invention is equally applicable to other types of airbags, such as knee bolsters, overhead airbags, inflatable curtains, side airbags, inflatable structural stiffeners, and the like.

The airbag module 10 is installed in a vehicle 12 having a longitudinal direction 14, a lateral direction 16, and a transverse direction 18. In this application, the terms “forward” and “rearward” refer to positions with respect to the vehicle 12. Thus, an item that is relatively closer to the front of the vehicle 12 is positioned “forward” of an item that is relatively closer to the rear of the vehicle 12. The second item is positioned “rearward” of the first.

As illustrated, the vehicle 12 has a seat 20 in which an occupant 22 is seated. The occupant 22 has a head 24, a torso 26, and a lap 28. A seat belt 30 provides primary restraint for the occupant 22. The vehicle 12 also has a front door 32 beside the occupant 22, a windshield 34 forward of the occupant 22, and an instrument panel 36 disposed generally underneath the windshield 24. The airbag module 10 is stowed within the instrument panel 36 and is seated in a mounting recess 38 of the instrument panel 36. The instrument panel 39 has a periphery 39, which is defined by the surface of the instrument panel 36 that is exposed to the passenger compartment of the vehicle 12.

As shown, the airbag module 10 has a cushion 40, which is illustrated in fully inflated form. The airbag module 10 also has an inflator 42 positioned within the instrument panel 36 to provide inflation gas to the cushion 40. The inflator 42 may be of any known type, including compressed gas, pyrotechnic, and hybrid inflators. The cushion 40 has an inflated configuration, as shown in FIG. 1, and a compacted configuration, in which the cushion 40 is stowed within the instrument panel 36 prior to deployment. The cushion 40 may optionally have a vent (not shown) formed therein to release inflation gas into the passenger compartment.

The airbag module 10 includes a housing 44 disposed within the instrument panel 36 to generally contain the inflator 42 and the cushion 40 in the compacted configuration. The cushion 40 is attached to the housing 44 in such a manner that inflation gas from the inflator 42 is directed through the housing 44 to reach the cushion 40. A number of lateral struts 46 pass through the instrument panel 36 and extend generally across the vehicle 12, or in the lateral direction 16. The housing 44 may be mounted to the lateral struts 46.

As will be described in greater detail subsequently, the airbag module 10 is designed such that the cushion 40 can be stowed with a relatively small thickness perpendicular to the periphery 39, and with a relatively broad area along the periphery 39. Thus, the cushion 40 inflates rapidly and within a relatively short time, is able to present a relatively broad impact surface to protect the occupant 22 from impact against the instrument panel 36 and/or the windshield 34.

The airbag module 10 also includes a cover 48, which is formed substantially of a plastic and/or foam like that used to form the remainder of the interior trim of the vehicle 12. When the cushion 40 is stowed within the instrument panel 36, the cover 48 provides an attractive facade that conceals the cushion 40 from the occupant 22 and matches the remaining trim. The cover 39 thus defines a portion of the periphery 39 of the instrument panel 36. The cover 48 may be designed to swing upward, as shown in FIG. 1, to permit the cushion 40 to inflate.

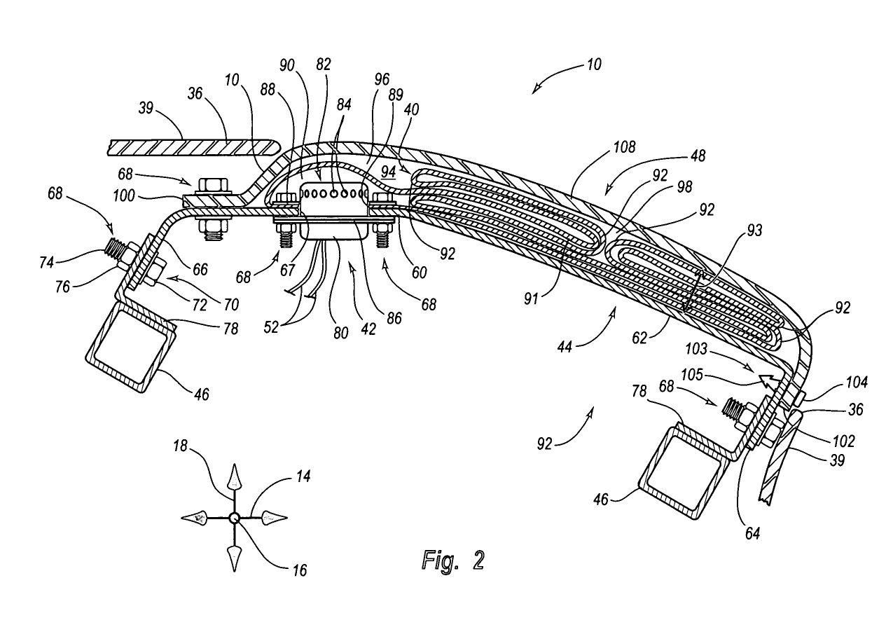

An electronic control unit 50, or ECU 50, is disposed within the vehicle 12. The ECU 50 need not be located as shown, but may be disposed at a variety of locations within the vehicle 12. The ECU 50 may be coupled to the inflator 42 via a set of wires 50. A collision sensor such as an accelerometer 54 or the like is coupled to the ECU 50 via wires 56. The accelerometer 54 transmits a signal to the ECU 50 to indicate that a collision is occurring or is about to occur. The ECU 50 then transmits an activation signal to the inflator 42 to trigger deployment of the inflator 42. The inflator 42 then releases inflation gas to inflate the cushion 40. The configuration and operation of the airbag module 10 will be explained with greater detail in connection with FIG. 2, as follows.

Referring to FIG. 2, an enlarged, a side elevation, section view illustrates the airbag module 10, with the cushion 40 in the compacted configuration. The cover 48 is closed over the cushion 40 in such a manner that the cushion 40 is concealed from the occupant 22.

As shown, the housing 44 has an inflator retention portion 60 and a cushion retention portion 62. The inflator 42 is seated against the inflator retention portion 60 and the cushion 42 is stowed above the cushion retention portion 62. The cushion retention portion takes the form of a generally planar “shallow pan” on which the cushion 40 rests. The housing 44 also has a first mounting flange 64 positioned adjacent to the periphery 39 of the instrument panel 36, and a second mounting flange 66 positioned on the opposite end of the housing 44, forward of the first mounting flange 64. The inflator retention portion 60 of the housing 44 has an inflator opening 67 through which the inflator 42 extends, as will be described subsequently.

Each of the mounting flanges 64, 66 is attached to one of the lateral struts 46 via an attachment device 68. The attachment devices 68 may take a variety of forms. However, in the embodiment of FIG. 2, each attachment device 68 includes a fastener 70 with a head 72 and a threaded stud 74 extending from the head 72. According to one example, the fasteners 70 may be PIM fasteners. Consequently, each of the heads 72 may have a splined shape (not shown) that that engages the surface against which the head 72 is pressed to keep the head 72 and the surface together. Alternatively, each fastener 70 may take the form of a conventional bolt or the like.

In addition to the fasteners 70, each of the attachment devices 68 may include a nut 76 that threadably engages the corresponding threaded stud 74 to provide secure attachment. Each of the mounting flanges 64, 66 is attached to an L-shaped bracket 78 via the corresponding attachment device 86. The L-shaped brackets 78 are welded or otherwise coupled to the lateral struts 46. Accordingly, the housing 44 is securely fastened to the lateral struts 46.

In FIG. 2, the inflator 42 is not sectioned to enhance the clarity of the drawing. The inflator 42 is displaced from the cover 48 by a relatively small displacement. Thus the inflator 42 is near the cover 48, rather than being recessed in the instrument panel 36, underneath the main body of the cushion 40. In this application, the displacement between the inflator 42 and the cover 48 is the separation between the parts of the inflator 42 and cover 48 that are closest to each other. The displacement between the inflator 42 and the cover 48 may advantageously be less than two inches, less than one-and-a-half inch, less than one inch, or even less than one-half inch.

The inflator 42 may be of a type commonly used for driver's side airbag modules. Accordingly, the inflator 42 may have a generally cylindrical shape, with a relatively small length along the axis of the inflator 42. In FIG. 2, the axis of the inflator 42 is oriented along the transverse direction 18. The inflator 42 has an electrical connection portion 80 extending from the underside of the housing 44, and a gas ejection portion 82 that extends through the inflator opening 67 of the housing 44 and into the cushion 40. The gas ejection portion 82 has an array of orifices 84 through which inflation gas is ejected from the interior of the inflator 42 and into the cushion 40. The orifices 84 are oriented radially, so that gas flows outward from the gas ejection portion 82 generally within the plane defined by the longitudinal and lateral directions 14, 16.

The inflator 42 has a flange 86 positioned between the electrical connection portion 80 and the gas ejection portion 82. The flange 86 extends generally parallel to the inflator retention portion 60. The flange 86 has holes (not shown) aligned with corresponding holes (not shown) formed in the inflator retention portion 60. Attachment devices 68, like those described previously, pass through the aligned holes to attach the flange 86 to the inflator retention portion 60.

In addition to the inflator opening 67 of the housing 44, the gas ejection portion 82 passes through a retention ring 88 and an inflator opening 89 of the cushion 40. The cushion 40 and the retention ring 88 have holes (not shown) aligned with those of the flange 86 and the inflator retention portion 60 to receive the attachment devices 68. The retention ring 88 has a relatively rigid structure that effectively clamps the adjoining portion of the cushion 40 against the inflator retention portion 60 of the housing 44, thereby holding the inflator opening 89 of the cushion 40 securely in place around the gas ejection portion 82 during inflation.

The gas ejection portion 82 is positioned to eject the inflation gas directly into an interior portion 90 of the cushion 40. As shown, the main bulk of the cushion 40 is disposed rearward of the inflator 42 so that the interior portion 90 is separated from the cover 48, and thus, from the periphery 39, by only a single layer of the material of which the cushion 40 is formed. The cushion 40 has a center 91, defined as the volumetric center of the envelope occupied by the cushion 40. The center 91 is positioned generally rearward of the inflator 42, and is thus displaced from the inflator 42 along a direction generally parallel to the periphery 39.

In this application, “generally parallel” does not require a precisely parallel disposition, but rather, that the direction be within 30° of parallelism. Similarly, “displaced primarily along” refers to a displacement that need not precisely follow the direction, but extends at an angle within 30° of the direction.

The cushion 40 is in its compacted configuration, in which the cushion 40 is compactly stowed. In this application, the phrase “compacted configuration” includes any configuration in which a flexible member is compactly stowed. The phrase includes both ordered folding according to a pre-established pattern, and randomized “chaos,” or compression folds. The cushion 40 has a plurality of folds 92 positioned on the cushion retention portion 62 of the housing 44. The cushion 40 may utilize a simple accordion-type fold with the pattern illustrated in FIG. 2, or with a similar pattern, to provide expedited inflation. In alternative embodiments of the invention, the cushion 40 may be compacted via rolling, simple compression, or the like.

The cushion 40 has a thickness 93 perpendicular to the periphery 39. The thickness 93 is relatively small, and in certain embodiments, may be under two inches. The thickness 93 may even be under one-and-a-half inches, under one inch, or even under one-half inch. The thickness 93 is small because the cushion 40, in its compacted configuration, extends along a relatively large area of the periphery 39 of the instrument panel.

The cushion 40 has a thickness perpendicular to the periphery 39 that is relatively small along substantially all of area along which the cushion 40 extends. In this application, stating that a compacted cushion has less than a given thickness along “substantially all” of an area does not require that no portion of the cushion be thicker than the given thickness. Rather, some small portions of the cushion may be thicker than the given thickness for purposes of attachment to an inflator or housing, or the like. The thickness of the main body of the cushion must simply be thinner than the given thickness. The thickness of a cushion is defined relative to the envelope occupied by the main body of the cushion.

As shown in FIG. 1, the cushion 40 extends generally along the longitudinal direction 14, nearly from the windshield 34 to the rearward extents of the instrument panel 36. The cushion 40 may extend for about twelve to about twenty-four inches in the longitudinal direction 14, or more specifically, for about eighteen to about twenty inches. The cushion 40 also extends for a relatively large distance in the lateral direction 16. The cushion 40 may extend for about twelve to about twenty-four inches in the lateral direction 16, or more specifically, for about sixteen to about twenty inches.

As a result, the cushion 40, in the compacted configuration, extends along a relatively large area of the periphery 39. The cushion 40 may extend along an area ranging from about 150 square inches to about 600 square inches. More precisely, the cushion 40 may extend along an area ranging from about 200 square inches to about 450 square inches. Yet more specifically, the cushion 40 may extend along an area ranging from about 250 square inches to about 350 square inches. The cushion may extend along an area of the periphery 39 of about 300 square inches.

The housing 44 and the cover 48 cooperate to define a space 94 within which the cushion 40 and the gas ejection portion 82 of the inflator 42 are disposed. More specifically, the space 94 includes an inflator portion 96 that contains the gas ejection portion 82 and a cushion portion 98 that contains the folds 92 of the cushion 40.

The cover 48 may be formed of a plastic and/or foam, like that of which vehicle trim is typically manufactured. The cover 48 may have a thickness and stiffness substantially equal to that of the surrounding vehicle trim. The cover 48 may be colored and/or textured to match the surrounding trim so that the presence of the cushion 40 is not generally detectable to the occupant 22. The cover 48 may have a fixed end 100 attached to a forward portion of the housing 44 by an attachment device 68 similar to those described previously.

Additionally, the cover 48 may have a removably fixed end 102 attached to a rearward portion of the housing 44 by a frangible fastener 103 designed to release the removably fixed end 102 in response to tension in the cover 48. The frangible fastener 103 may have any of a wide variety of configurations. In FIG. 2, the frangible fastener 103 has a head 104 and a tapered stud 105 that extends from the head. The tapered stud 105 may have a “Christmas tree” configuration or the like. The tapered stud 105 passes through a hole (not shown) in the first mounting flange 64. The frangible fastener 105 may be formed of a material such as plastic, so that when the cushion 40 begins to inflate, the resulting tension on the cover 48 causes the head 104 to shear off to release the removably fixed end 102.

The cover 48 also has a hinge portion 106 positioned adjacent to the fixed end 100 and a central portion 108 that covers the cushion 40. If desired, the hinge portion 106 may be made thinner than the remainder of the cover 48, or may otherwise be made relatively pliable. Alternatively, the cover 48 may be expected to bend at the hinge portion 106 without requiring any bend-facilitating geometry. Thus, when the frangible fastener 103 breaks, the cover 48 is able to open to assume the position illustrated in FIG. 1, thereby releasing the cushion 40.

In this application, the term “frangible,” as applied to a cover, includes covers that are removably attachable, like the cover 48, and covers that are designed to tear open to release the associated cushion, as will be shown and described in connection with subsequent embodiments. “Detachment” of an end of a cover from a housing may be performed via a frangible fastener such as the frangible fastener 103, or via tearing of the cover material.

When the ECU 50 transmits an activation signal to the inflator 42, the inflator 42 deploys to release inflation gas directly into the interior portion 90 of the cushion 40 through the orifices 84. The inflation gas causes the cushion 40 to expand, and the cushion 40 presses against the cover 48. The frangible fastener 103 breaks to permit the cover 48 to open in the manner described above, thereby permitting the cushion 40 to fully inflate into the protective position shown in FIG. 1.

Due to the fact that the cushion 40, in the compacted configuration, extends along a large area of the periphery 39, and due to the fact that the thickness 93 is small, a relatively small amount of energy is required to move the cushion 40 from the compacted configuration shown in FIG. 2 to the deployed configuration illustrated in FIG. 1. Additionally, the cushion need not extend fully toward the occupant 22 before expanding to provide a larger impact surface. Rather, a relatively large impact surface is provided by the cushion 40 at the commencement of inflation. Thus, the cushion 40 may provide enhanced protection for an occupant 22 that is out-of-position, such as an occupant 22 that is not wearing the seat belt 30.

As mentioned previously, the housing 44 may be constructed such that the housing 44 is able to deform in response to impact. More precisely, when the occupant 22 impacts the inflated cushion 40, the resulting pressure rise within the cushion 40 may cause the cushion retention portion 62 of the housing 44 to bend inward, into the instrument panel 36. Deformation of the housing 44 provides a softer impact against the cushion 40 because some of the inflation gas within the cushion 40 is able to move into the deformed housing 44.

The housing 44 may also deform if the cover 48 is impacted directly by the occupant 22, which may possibly occur prior to deployment of the airbag module 10 if the occupant 22 is out-of-position. The placement of the inflator 42 forward of the center 91 of the cushion 40 provides a relatively large, deformable area proximate the rearward edge of the instrument panel 36 to receive occupant impact. With the inflator 42 positioned proximate the windshield 34, the occupant 22 is unlikely to strike the instrument panel 36 in such a manner as to impact the inflator 42.

The airbag module 10 is easily manufactured and assembled. According to one example, the cushion 40 may be made from various fabric panels, formed of a woven nylon material or the like, that are attached together via sewing, one-piece weaving (OPW), or the like to form the desired three-dimensional shape of the cushion 40. The inflator 42 may be formed and filled with pyrotechnic and or compressed gas materials according to known methods. The housing 44 may be formed of a metallic material via a method such as stamping, or may be formed of a plastic via a method such as injection molding or extrusion. The cover 48 may also be formed of a solid plastic and/or foam via injection molding or the like.

According to one assembly method, fasteners 70 are inserted through the holes of the retention ring 88, the cushion 40, the inflator retention portion 60 of the housing 44, and the flange 86 of the inflator 42. The corresponding nuts 76 are then rotated into engagement with the fasteners 70 to attach the inflator 42, cushion 40, and retention ring 88 to the inflator retention portion 60. The cushion 40 is folded in the manner illustrated and placed on the cushion retention portion 62. The cover 48 is attached to the housing 44 via the corresponding attachment device 68 and the frangible fastener 103 to complete assembly of the airbag module 10. The airbag module 10 may then be installed in the instrument panel 36 by attaching the mounting flanges 64, 66 to the corresponding L-shaped brackets 78 via the corresponding attachment devices 68. The foregoing steps are merely exemplary; other manufacturing and assembly processes may be followed within the scope of the present invention.

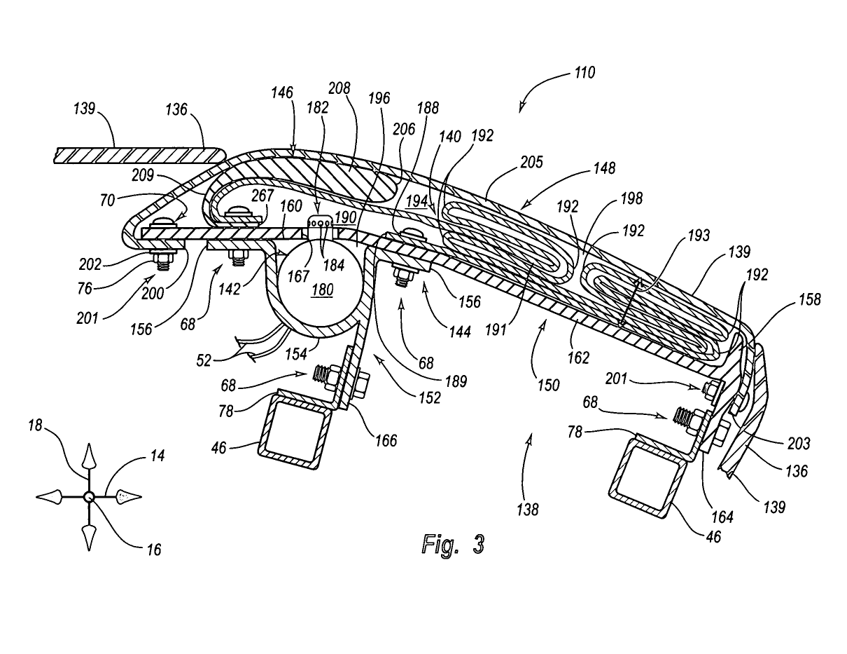

Referring to FIG. 3, a side elevation, perspective view illustrates an airbag module 110 according to one alternative embodiment of the invention. As shown, the airbag module 110 is installed in an instrument panel 136 which may be shaped slightly differently from the instrument panel 36 of the previous embodiment. The instrument panel 136 has a mounting recess 138 that receives the airbag module 110, and a periphery 139 that defines the surface of the instrument panel 136 that is exposed to the passenger compartment of the vehicle in which the airbag module 110 is installed.

The airbag module 110 includes a cushion 140, which is similar to the cushion 40 of the previous embodiment. Also, the airbag module 110 includes an inflator 142, a housing 144, a tear initiation member 146, and a cover 148, which differ in a number of ways from their counterparts in the previous embodiment.

More precisely, the housing 144 may include two separate pieces: a first piece 150 and a second piece 152. The first piece 150 is generally designed to receive the cushion 140, and may also be designed to deflect in response to impact against the inflated cushion 140. Accordingly, the first piece 150 may be made of plastic or relatively thin sheet metal. The second piece 152 is designed to retain the inflator 142 and may bear more of the weight of the airbag module 110. Accordingly, the second piece 152 may be formed of a heavier gauge metal or the like. Alternatively, the second piece 152 may be formed of plastic.

As shown, the second piece 152 is shaped to form an inflator alcove 154 in which the inflator 42 rests. The inflator alcove 154 has a generally hemi-cylindrical shape, which flares out to form attachment flanges 156 that extend generally parallel to the first piece 150. The second piece 152 is attached to the first piece 150 and to the cushion 140 via attachment devices 68 like those of the previous embodiment.

The first piece 150 has a lip 158 positioned toward its rearward edge to help retain the cushion 140. The first piece 150 also has an inflator retention portion 160 to which the second piece 152 is attached, and a cushion retention portion 162 on which the cushion 140 generally rests. The first piece 150 has a first mounting flange 164 and the second piece 152 has a second mounting flange 166. The inflator retention portion 160 has an inflator opening 167 through which a part of the inflator 142 extends to eject inflation gas directly into the cushion 140, as will be discussed in greater detail subsequently.

Each of the mounting flanges 164, 166 is attached to an L-shaped bracket 78, like those of the previous embodiment, via attachment devices 68. As in the previous embodiment, the L-shaped brackets 78 are attached to the lateral struts 46 via welding or other methods. Accordingly, the airbag module 110 is securely mounted to the lateral struts 46.

The inflator 142 may be of a type commonly used for passenger's side, frontal impact airbag modules. In FIG. 3, the inflator 142 is not sectioned to enhance the clarity of the drawing. More precisely, the inflator 142 may have a main body 180 with a generally cylindrical shape, with an axis extending generally along the lateral direction 16. The inflator 142 also has a diffuser 182 extending from the main body 180, along the transverse direction 18. The diffuser 182 may extend from approximately halfway along the length of the main body 180. The diffuser 182 has a plurality of orifices 184 through which inflation gas flows from the inflator 142 to enter the cushion 140.

The airbag module 110 also includes a retention ring 188 somewhat similar to that of the previous embodiment. The retention ring 188 may be generally ring-shaped, and may have holes (not shown) through which fasteners 70 pass to attach the retention ring 188, the cushion 140, the first piece 150, and the second piece 152 together. The cushion 140 has an inflator opening 189 concentric with the inflator opening 167 of the inflator retention portion 160 of the first piece 150 of the housing 144. The diffuser 182 of the inflator 142 protrudes into an interior portion 190 of the cushion 140 through the inflator opening 189 so that inflation gas exiting the diffuser 182 flows directly into the interior portion 190.

The cushion 140 has a center 191, which is defined in the same manner as in the previous embodiment. The center 191 is displaced from the inflator 142 along a direction generally parallel to the periphery 139, i.e., the adjacent portion of the cover 148. More precisely, the center 191 is disposed generally rearward of the inflator 142. The cushion 140 has a plurality of folds 192 positioned on the cushion retention portion 162 of the first piece 150 of the housing 144. As in the previous embodiment, the cushion 140 has a relatively small thickness 193 perpendicular to the periphery 139. The cushion 140 also extends for a comparatively large area along the periphery 139.

The housing 144 and the cover 148 cooperate to define a space 194 within which the inflator 142 and the cushion 140 are stowed. The space 194 includes an inflator portion 196 containing the inflator 142 and a cushion portion 198 containing the cushion 140.

By contrast with the previous embodiment, the cover 148 may take the form of a membrane with a thickness much smaller than that of the surrounding vehicle trim. The cover 148 may the thin enough to be flexible, much like a fabric. Indeed, the cover 148 may be formed of a fabric, a thin plastic, or the like. In this application, the term “membrane” refers to a structure that is thinner than conventional vehicle trim and is thin enough to flex in a manner similar to that of a fabric, such as an airbag fabric.

The cover 148 has a first fixed end 200, which is attached to the first piece 150 of the housing 144 via an attachment device 201 similar to the attachment devices 68. The attachment device 201 may include a fastener 70 and a nut 76, and may also include a washer 202 positioned between the nut 76 and the first fixed end 200 to prevent the nut 76 from damaging the first fixed end 200 when the attachment device 201 is installed. The cover 148 also has a second fixed end 203, which may be attached to the first piece 150 via another attachment device 201. The cover 148 also has a central portion 205 that extends generally over the folds 198 of the cushion 140.

The ends 200, 203 are not designed to break away from the housing 144. Rather, the tear initiation member 146 is provided to initiate a tear in the cover 148 to release the cushion 140. More precisely, the tear initiation member 146 has a tear initiating end 206, which may have a relatively sharp edge or a relatively square corner. The tear initiation member 146 also has a fixed end 207 with holes (not shown) through which one or more of the attachment devices 68 extend to affix the fixed end 207 between the adjacent portions of the cushion 140 and the inflator retention portion 160.

The tear initiation member 146 may also have a stiff portion 208 adjacent to the tear initiating end 206 and a hinge portion 209 adjacent to the fixed end 207. Thus, the tear initiating end 206 is able to swing upward and forward such that the tear initiating end 206 impinges against the adjacent portion of the cover 148. A tear is formed proximate the central, forward portion of the cover 148. The tear propagates to either side in the lateral direction 16, and then rearward along the cover 148 to provide a generally U-shaped deployment door through which the cushion 140 is able to inflate. The deployment door may swing open rearward and hang rearward of the instrument panel 136 when the cushion 140 inflates.

Prior to inflation, the tear initiation member 146 serves to define the shape of the space 194 within which the cushion 140 and the inflator 142 are disposed. The central portion 205 of the cover 148 may be stretched relatively tightly along the space between the stiff portion 208 of the tear initiation member 146 and the end of the lip 158. Thus, the cushion 148 need not press outward against the central portion 205. Accordingly, it is relatively unlikely that the folds 192 of the cushion 140 will be visible to a person looking at the outside surface of the cover 148. Additionally, any folding irregularities in the cushion 140 are unlikely to be visible through the cover 148.

After the inflator 142 receives an activation signal, inflation gas exits the inflator 142 via the orifices 184 in the diffuser 182. The inflation gas flows directly into the interior portion 190 of the cushion 140 and the cushion 140 begins to expand. The cushion 140 presses against the stiff portion 208 of the tear initiation member 146 and the tear initiating end 206 pivots upward, against the interior surface of the cover 148 to rupture the cover 148. The cover 148 opens in the manner described previously and the cushion 140 inflates through the opening in the cover 148 to provide impact protection. As the cushion 140 inflates, the tear initiation member 146 may continue to pivot upward and forward so that the stiff portion 208 does not obstruct the inflation path of the cushion 140.

During deployment, the airbag module 110 may provide the same benefits cited in connection with the previous embodiment, due to the relatively small thickness 191 of the compacted cushion 140 and the large area of the periphery 139 along which the cushion 140 extends. The cushion retention portion 162 of the first piece 150 may also deform in response to impact of the occupant 22 against the inflated cushion 140 or against the cover 148 prior to deployment.

The airbag module 110 may be manufactured and assembled according to a wide variety of methods. According to one method, the cushion 140 may be manufactured via methods set forth in connection with the cushion 40 of the previous embodiment. The inflator 142 may be constructed via known methods. The first and second pieces 150, 152 of the housing 144 may be formed via molding, stamping, extrusion, or the like, depending on whether plastic or metal materials are used. The tear initiation member 146 may be formed of plastic via molding or the like, and the cover 148 may be molded or woven.

According to one method of assembly, the inflator 142 may first be inserted into the inflator alcove 154 of the second piece 152. The retention ring 188 and the adjoining portion of the cushion 140, the fixed end 207 of the tear initiation member 146, the first piece 150 of the housing 144, and the second piece 152 may then be attached together via the attachment devices 68. The inflator 142 is then captured between the first and second pieces 150, 152 such that the diffuser 182 extends through the inflator opening 167 and the inflator opening 189, as shown.

The cushion 140 is then folded in the manner shown, and the folds 192 are disposed to rest on the cushion retention portion 162 of the first piece 150 of the housing 144. The cover 148 is then stretched relatively tightly over the tear initiation member 146 and the cushion 140, and the fixed ends 200, 203 are attached to the first piece 150 via the attachment devices 201 to complete assembly of the airbag module 110. The airbag module 110 may then be installed in the instrument panel 136 by attaching the mounting flanges 164, 166 to the corresponding L-shaped brackets 78 via the corresponding attachment devices 68. The foregoing steps are merely exemplary; other manufacturing and assembly processes may be followed within the scope of the present invention.

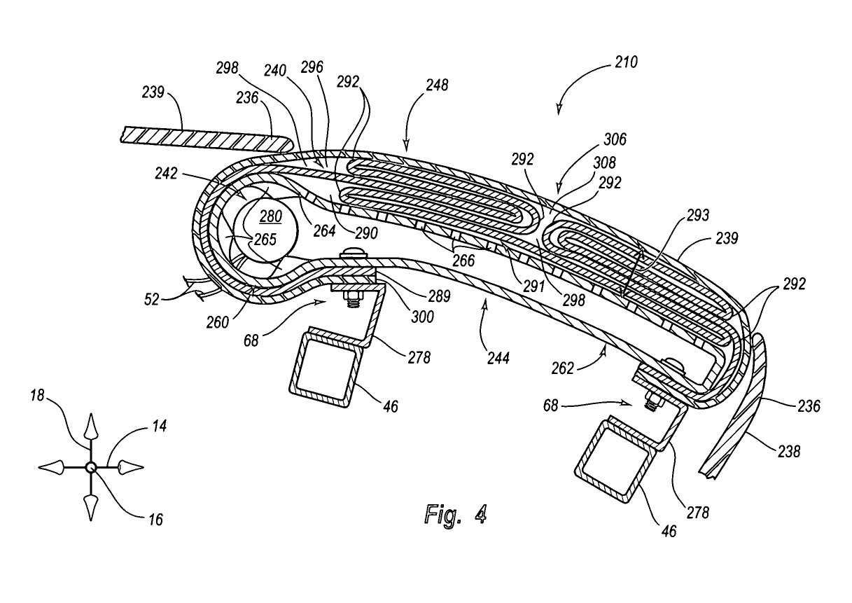

Referring to FIG. 4, a side elevation, section view illustrates an airbag module 210 according to another alternative embodiment of the invention. The airbag module 210 is installed in an instrument panel 236, which may be shaped slightly differently from the instrument panels 36, 136 of the previous embodiments. The instrument panel 236 has a mounting recess 238 in which the airbag module 210 is seated. The instrument panel 236 also has a periphery 239, which is defined by the surface of the instrument panel 236 that is exposed to the passenger compartment of the vehicle 12 in which the airbag module 210 is installed.

The airbag module 210 has a cushion 240, which may have a shape similar to the cushions 40, 140 of the previous embodiments. The airbag module 210 also has an inflator 242, a housing 244, and a cover 248 that are configured differently from their counterparts of the previous two embodiments.

As shown in FIG. 4, the housing 244 is shaped to form a diffuser that distributes the inflation gas flowing into the cushion 240 in a relatively uniform manner. The housing 244 therefore has a generally enclosed shape that defines an inflator retention portion 260 and a cushion retention portion. The inflator 242 is contained within the inflator retention portion 260. The inflator retention portion has an inflator containment wall 264 with a generally cylindrical shape. A plurality (for example, three) inflator retention extensions 265 extend inward from the inflator containment wall 264 to securely hold the inflator 242 in place, while leaving space around all sides of the inflator 242 for inflation gas to exit the inflator 242 and move into the cushion retention portion 262.

The cushion 240 is disposed to rest generally on the cushion retention portion 262. The cushion retention portion 262 has a generally planar shape with a plurality of orifices 266 distributed along the adjacent area of the cushion 240. The orifices 266 are also distributed along the cushion retention portion 262, in the lateral direction 16, which extends out of the page with respect to the view of FIG. 4. The orifices 266 may be sized to provide a flow restriction so that the inflation gas enters the cushion 240 at the desired aggregate flow rate.

If desired, the pattern of distribution of the orifices 266 or the sizes of the orifices 266 may be altered along the length of the cushion retention portion 262 to provide a relatively uniform flow of inflation gas into the cushion. For example, orifices 266 further from the inflator 242 may be made larger or may be spaced closer together than those close to the inflator 242 to compensate for the longer flow path of the inflation gas. Thus, the flow rate of inflation gas from the rearward portion of the cushion retention portion 262 may be equalized with that of the forward portion of the cushion retention portion 262.

The underside of the housing 244 is attached to a pair of C-shaped brackets 278 via attachment devices 68 like those of the previous embodiments. The C-shaped brackets 278 are welded or otherwise attached to the lateral struts 46 passing through the instrument panel 36. Accordingly, the airbag module 210 is securely mounted within the instrument panel 236.

The inflator 242 is not shown in section in FIG. 4 for clarity. The inflator 242 may have a main body 280 with a generally cylindrical, elongated shape with an axis extending along the lateral direction 16. The inflator 242 may have a plurality of orifices (not visible) distributed about the main body 280 to eject inflation gas radially outward from the main body 280. The inflation gas may be ejected into a plane defined generally by the longitudinal and transverse directions 14, 18. The housing 244 is shaped such that the inflation gas is able to flow from the inflator retention portion 260 into the cushion retention portion 262.

As shown, the housing 244 is generally contained within the cushion 240. The cushion 240 has a housing opening 289 through which the housing 244 may be inserted into the cushion 240. The cushion 240 also has an interior portion 290 into which inflation gas passes after exiting the housing 244 through the orifices 266. The cushion 240 has a center 291 defined in a manner similar to that of the center 91 of the cushion 40 of FIGS. 1 and 2. The center 291 is displaced from the inflator 242 along a direction generally parallel to the adjoining portion of the periphery 239, and is more specifically positioned generally rearward of the inflator 242.

The cushion 240 may be folded in a manner somewhat similar to that of the previous embodiments. Thus, the cushion 240 may have a plurality of folds 292 that form a somewhat simple accordion fold pattern. In the alternative, roll folds and/or compression folds may be used to compact the cushion 240. As in the previous embodiments, the cushion 240 has a relatively small thickness 293 perpendicular to the periphery 239. The cushion 240 also extends for a comparatively large area along the periphery 239. The thickness 293 includes only the main, folded body of the cushion 240 because the portions of the cushion 240 that extend around the housing 244 are not movable and do not add to the thickness of the airbag module 210, perpendicular to the periphery 239. This is consistent with the manner in which “thickness” is used in the appended claims.

The bottom wall of the housing 244 and the cover 248 cooperate to define a space 294 that contains the inflator 242 and the cushion 240. The space includes an inflator portion 296, within which the inflator 242 is positioned (within the housing 244) and a cushion portion 298, within which the cushion 240 is stowed.

The housing opening 289 is positioned such that the housing 244 is located within the cushion 240. Thus, the housing opening 289 is disposed generally underneath the cushion retention portion 262 of the housing 244. The portion of the cushion 240 surrounding the housing opening 289 is gripped between the cushion retention portion 262 and the C-shaped brackets 278. Additionally, the cover 248 may have two fixed ends 300, each of which is also retained between the cushion retention portion 262 and the C-shaped brackets 278. Thus, the cushion 240 and the cover 248 are both retained securely against the housing 244 such that the cushion 240 contains the housing 244 and the cover 248 contains the cushion 240 and the housing 244.

As in the previous embodiment, the cover 248 is a membrane with a thickness much smaller than that of the surrounding vehicle trim. The cover 248 is thin enough to flex in a manner similar to that of a fabric, such as a fabric typically used to form airbag cushions. The cover 248 has a central portion 306 that covers the cushion. In the embodiment of FIG. 4, no tear initiation member is present. Rather, the cover 248 is stretched directly over the cushion 240, and the central portion 306 has a score 308 that extends along the lateral direction 16, near the center of the folded portion of the cushion 240.

After the inflator 242 receives an activation signal, inflation gas exits the inflator 242 radially outward to enter the inflator retention portion 260 of the housing 244. From the inflator retention portion 260, the inflation gas flows into the cushion retention portion 262. The inflation gas flows through the orifices 266 and into the cushion 240. As a result, the cushion 240 begins to inflate and presses against the interior of the central portion 306 of the cover 248. The resulting tension in the cover 248 causes the cover 248 to split open along the score 308. The cushion 240 inflates through the resulting opening. The opening in the cover 248 may tear further or may stretch open to permit the cushion 240 to inflate and receive impact from the occupant 22.

During deployment, the airbag module 210 may provide the same benefits cited in connection with the previous embodiment, due to the relatively small thickness 291 of the compacted cushion 240 and the large area of the periphery 239 along which the cushion 240 extends. The cushion retention portion 262 of the housing may also deform in response to impact of the occupant 22 against the inflated cushion 240 or against the cover 248 prior to deployment. If desired, both generally planar walls of the cushion retention portion (i.e., the top and bottom walls) may deform in response to impact.

The airbag module 210 may be manufactured and assembled according to a wide variety of methods. According to one method, the cushion 240 may be manufactured via methods set forth in connection with the cushions 40, 140 of the previous embodiments. The inflator 242 may be constructed via known methods. The housing 244 may be formed of a metal via stamping, extrusion, or the like. If desired, a method such as extrusion may be used to obtain the overall shape of the housing 244, and then stamping or other methods may be applied to form the orifices 266 and the inflator retention extensions 265. Alternatively, the housing 244 may be formed of a plastic via molding or other known methods.

According to one method of assembly, the inflator 242 may first be inserted into the inflator retention portion 260 of the housing 244 such that the inflator 242 is retained by the inflator retention extensions 265. The housing 244 and the inflator 242 may then be inserted into the cushion 240 through the housing opening 289, and the cushion 240 may be folded in the manner shown to lie against the cushion retention portion 262 of the housing. The cover 248 may be wrapped snugly around the housing 244 and the cushion 240. The cushion retention portion 262 of the housing 244, the adjoining portion of the cushion 240, and the fixed ends 300 of the cover 248 may then be attached together via application of the attachment devices 268 to complete assembly of the airbag module 210. 100971 The airbag module 210 may then be installed in the instrument panel 236 by attaching the attachment devices 68, which have already been attached to the cushion 240, housing 244, and cover 248, to the C-shaped brackets 278. The foregoing steps are merely exemplary; other manufacturing and assembly processes may be followed within the scope of the present invention.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An airbag module for protecting an occupant of a vehicle from impact, the airbag module comprising:
an inflator that produces inflation gas in response to receipt of an activation signal; and
a cushion positionable within an instrument panel of the vehicle to receive the inflation gas such that the cushion inflates to provide impact protection, wherein the cushion is in a compacted configuration in which the cushion has a small thickness perpendicular to a periphery of the instrument panel, the cushion having an area greater than 150 square inches parallel to the periphery.

2. The airbag module of claim 1, wherein the area is greater than 200 square inches.

3. The airbag module of claim 2, wherein the area is greater than 250 square inches.

4. The airbag module of claim 1, wherein the thickness perpendicular to the periphery is less than two inches along substantially all of the area.

5. The airbag module of claim 2, wherein the thickness perpendicular to the periphery is less than one inch along substantially all of the area.

6. The airbag module of claim 5, wherein the thickness perpendicular to the periphery is less than one-half inch along substantially all of the area.

7. The airbag module of claim 1, further comprising a cover extending along the periphery to conceal the cushion from the occupant, wherein the cover is frangible to permit emergence of the cushion through the periphery.

8. The airbag module of claim 7, wherein the cover comprises a forward edge and a rearward edge, wherein, in response to expansion of the cushion, a bulge is formed proximate the forward edge and the rearward edge is detached from the instrument panel to permit the cover to open.

9. The airbag module of claim 7, wherein the cover comprises a forward edge and a rearward edge, wherein, in response to expansion of the cushion, the cover tears along the forward edge and then rearward of the forward edge to provide a generally U-shaped tear seam.

10. The airbag module of claim 7, wherein the cover comprises a membrane having a pliable construction.

11. The airbag module of claim 10, further comprising a tear initiation member having a generally rigid construction, wherein the tear initiation member is positioned between the cushion and the membrane, the tear initiation member having an edge that is movable in response to pressure from the cushion to form a tear in the membrane.

12. The airbag module of claim 1, wherein the inflator and the cushion are both positioned proximate the periphery and the inflator is displaced from a center of the cushion primarily along a direction parallel to the periphery.

13. The airbag module of claim 12, wherein the inflator is positioned forward of the cushion.

14. The airbag module of claim 12, further comprising a housing positionable to retain the inflator and the cushion, wherein the housing has a generally planar shape oriented generally parallel to the cushion.

15. The airbag module of claim 14, wherein the housing comprises a generally rigid structure that is deformable in response to impact of the occupant against the cushion to absorb kinetic energy from the occupant.

16. The airbag module of claim 12, further comprising a diffuser having a generally planar shape oriented generally parallel to the cushion, wherein the diffuser comprises a plurality of orifices positioned to receive inflation gas from along a direction generally parallel to the cushion and to direct the inflation gas into the cushion.

17. An airbag module for protecting an occupant of a vehicle from impact, the airbag module comprising:
an inflator that produces inflation gas in response to receipt of an activation signal;
a cushion positionable within an instrument panel of the vehicle to receive the inflation gas such that the cushion inflates to provide impact protection; and
a cover extending along the periphery to conceal the cushion from the occupant;
wherein the inflator is positioned to eject the inflation gas directly into an interior portion of the cushion, wherein the interior portion is separated from the cover by only a single layer of a material of which the cushion is formed.

18. The airbag module of claim 17, wherein the cover comprises a forward edge and a rearward edge, wherein, in response to expansion of the cushion, a bulge is formed proximate the forward edge and the rearward edge is detached from the instrument panel to permit the cover to open.

19. The airbag module of claim 17, wherein the cover comprises a forward edge and a rearward edge, wherein, in response to expansion of the cushion, the cover tears along the forward edge and then rearward of the forward edge to provide a generally U-shaped tear seam.

20. The airbag module of claim 17, wherein the cover comprises a membrane having a pliable construction.

21. The airbag module of claim 20, further comprising a tear initiation member having a generally rigid construction, wherein the tear initiation member is positioned between the cushion and the membrane, the tear initiation member having an edge that is movable in response to pressure from the cushion to form a tear in the membrane.

22. The airbag module of claim 17, wherein the inflator and the cushion are both positioned proximate the periphery and the inflator is displaced from a center of the cushion primarily along a direction parallel to the periphery.

23. The airbag module of claim 22, wherein the inflator is positioned forward of the cushion.

24. The airbag module of claim 22, further comprising a housing positionable to retain the inflator and the cushion, wherein the housing has a generally planar shape oriented generally parallel to the cushion.

25. The airbag module of claim 24, wherein the housing comprises a generally rigid structure that is deformable in response to impact of the occupant against the cushion to absorb kinetic energy from the occupant.

26. The airbag module of claim 17, wherein the cushion comprises a plurality of folds displaced from the interior portion along a direction generally parallel to the periphery.

27. An airbag module for protecting an occupant of a vehicle from impact, the airbag module comprising:
an inflator that produces inflation gas in response to receipt of an activation signal;
a cushion positionable within an instrument panel of the vehicle to receive the inflation gas such that the cushion inflates to provide impact protection, wherein the cushion is in a compacted configuration in which the cushion has a small thickness perpendicular to a periphery of the instrument panel; and
a housing positionable within the instrument panel to retain the inflator and the cushion such that the inflator and the cushion, in the compacted configuration, are both positioned proximate the periphery and the inflator is displaced from a center of the cushion primarily along a direction parallel to the periphery.

28. The airbag module of claim 27, further comprising a cover extending along the periphery to conceal the cushion from the occupant, wherein the cover is frangible to permit emergence of the cushion through the periphery.

29. The airbag module of claim 28, wherein the cover comprises a forward edge and a rearward edge, wherein, in response to expansion of the cushion, a bulge is formed proximate the forward edge and the rearward edge is detached from the instrument panel to permit the cover to open.

30. The airbag module of claim 28, wherein the cover comprises a forward edge and a rearward edge, wherein, in response to expansion of the cushion, the cover tears along the forward edge and then rearward of the forward edge to provide a generally U-shaped tear seam.

31. The airbag module of claim 28, wherein the cover comprises a membrane having a pliable construction.

32. The airbag module of claim 31, further comprising a tear initiation member having a generally rigid construction, wherein the tear initiation member is positioned between the cushion and the membrane, the tear initiation member having an edge that is movable in response to pressure from the cushion to form a tear in the membrane.

33. The airbag module of claim 28, wherein the inflator is displaced from the cover by a distance of less than two inches.

34. The airbag module of claim 27, wherein the inflator is positioned forward of the cushion.

35. The airbag module of claim 27, wherein the housing has a generally planar shape oriented generally parallel to the cushion.

36. The airbag module of claim 35, wherein the housing comprises a generally rigid structure that is deformable in response to impact of the occupant against the cushion to absorb kinetic energy from the occupant.

37. The airbag module of claim 27, wherein the housing comprises a diffuser having a generally planar shape oriented generally parallel to the cushion, wherein the diffuser comprises a plurality of orifices positioned to receive inflation gas from along a direction generally parallel to the cushion and to direct the inflation gas into the cushion.

38. An airbag module for protecting an occupant of a vehicle from impact, the airbag module comprising:
an inflator that produces inflation gas in response to receipt of an activation signal;
a cushion positionable to receive the inflation gas such that the cushion inflates to provide impact protection; and
a housing positionable to retain the inflator and the cushion, wherein the housing comprises a generally rigid structure that is deformable in response to impact of the occupant against the cushion to absorb kinetic energy from the occupant.

39. The airbag module of claim 38, wherein the cushion is positionable within an instrument panel of the vehicle, the airbag module further comprising a cover extending along a periphery of the instrument panel to conceal the cushion from the occupant, wherein the cover is frangible to permit emergence of the cushion through the periphery.

40. The airbag module of claim 39, wherein the cover comprises a forward edge and a rearward edge, wherein, in response to expansion of the cushion, a bulge is formed proximate the forward edge and the rearward edge is detached from the instrument panel to permit the cover to open.

41. The airbag module of claim 39, wherein the cover comprises a forward edge and a rearward edge, wherein, in response to expansion of the cushion, the cover tears along the forward edge and then rearward of the forward edge to provide a generally U-shaped tear seam.

42. The airbag module of claim 39, wherein the cover comprises a membrane having a pliable construction.

43. The airbag module of claim 42, further comprising a tear initiation member having a generally rigid construction, wherein the tear initiation member is positioned between the cushion and the membrane, the tear initiation member having an edge that is movable in response to pressure from the cushion to form a tear in the membrane.

44. The airbag module of claim 38, wherein the cushion is positionable within an instrument panel of the vehicle, wherein the inflator and the cushion are both positioned proximate a periphery of the instrument panel and the inflator is displaced from a center of the cushion primarily along a direction parallel to the periphery.

45. The airbag module of claim 44, wherein the inflator is positioned forward of the cushion.

46. The airbag module of claim 45, wherein the housing is positioned to retain the inflator and the cushion, wherein the housing has a generally flat surface oriented generally parallel to the cushion, wherein the generally flat surface is bendable into the instrument panel in response to pressure of inflation gas within the cushion.

47. The airbag module of claim 44, wherein the housing comprises a diffuser having a generally planar shape oriented generally parallel to the cushion, wherein the diffuser comprises a plurality of orifices positioned to receive inflation gas from along a direction generally parallel to the cushion and to direct the inflation gas into the cushion.

48. A method for manufacturing an airbag module for protecting an occupant of a vehicle from impact, wherein the airbag module is designed to be installed in an instrument panel of the vehicle, the instrument panel having a periphery, the airbag module having an inflator, a cushion, and a housing, the method comprising:
compacting the cushion; and
coupling the inflator and the cushion to the housing such that the cushion is positioned to receive inflation gas from the inflator, wherein the cushion, housing, and inflator form the airbag module shaped such that, after installation in the instrument panel, the cushion has a small thickness perpendicular to the periphery and an area greater than 150 square inches parallel to the periphery.

49. The method of claim 48, wherein the area is greater than 250 square inches.

50. The method of claim 48, wherein the thickness perpendicular to the periphery is less than two inches along substantially all of the area.

51. The method of claim 48, wherein the airbag module further comprises a cover that is frangible to permit emergence of the cushion through the periphery, the method further comprising coupling the cover to the housing such that, after installation of the airbag module in the instrument panel, the cover extends along the periphery to conceal the cushion from the occupant.

52. The method of claim 51, wherein the cover comprises a membrane having a pliable construction, wherein coupling the cover to the cushion comprises stretching the membrane over the cushion.

53. The method of claim 52, wherein airbag module further comprises a tear initiation member having a generally rigid construction, the method further comprising positioning the tear initiation member between the cushion and the membrane, wherein the tear initiation member has an edge that is movable in response to pressure from the cushion to form a tear in the membrane.

54. The method of claim 48, wherein coupling the inflator and the cushion to the housing comprises positioning the inflator and the cushion such that, after installation of the airbag module in the instrument panel, the inflator and the cushion are both proximate the periphery and the inflator is displaced from a center of the cushion primarily along a direction parallel to the periphery.

55. The method of claim 54, coupling the inflator and the cushion to the housing comprises positioning the inflator and the cushion such that, after installation of the airbag module in the instrument panel, the inflator is forward of the cushion.

56. The method of claim 54, wherein the housing has a generally planar shape, wherein coupling the inflator and the cushion to the housing comprises orienting the housing generally parallel to the cushion, wherein the housing comprises a generally rigid structure that is deformable in response to impact of the occupant against the cushion to absorb kinetic energy from the occupant.

57. The method of claim 54, wherein the housing is shaped to form a diffuser having a generally planar shape with a plurality of orifices, wherein coupling the inflator and the cushion to the housing comprises orienting the diffuser generally parallel to the cushion such that the orifices are positioned to receive inflation gas from along a direction generally parallel to the cushion and to direct the inflation gas into the cushion.

58. A method for protecting an occupant of a vehicle from impact through the use of an airbag module installed in an instrument panel of the vehicle, the airbag module comprising an inflator, a cushion, and a cover, the method comprising:
transmitting an activation signal to trigger production of inflation gas by the inflator;
ejecting the inflation gas from the inflator directly into an interior portion of the cushion, wherein the interior portion is separated from the cover by only a single layer of a material of which the cushion is formed, wherein the cover extends along a periphery of the instrument panel; and
rupturing the cover to permit the cushion to emerge from within the instrument panel to provide impact protection.

59. The method of claim 58, wherein the cover comprises a forward edge and a rearward edge, wherein rupturing the cover comprises:
forming a bulge proximate the forward edge; and
detaching the rearward edge from the instrument panel to permit the cover to open.

60. The method of claim 58, wherein the inflator and the cushion are both positioned proximate the periphery and the inflator is displaced forward of the cushion, wherein ejecting the inflation gas from the inflator directly into the interior portion comprises moving the inflation gas rearward.

61. The method of claim 60, wherein the airbag module further comprises a housing positioned to retain the cushion and the inflator, the housing having a generally planar shape, the method further comprising:
receiving impact of the occupant against the cushion; and
deforming the housing in response to impact of the occupant against the cushion to absorb kinetic energy from the occupant.

62. The method of claim 58, wherein the cushion comprises a plurality of folds displaced from the interior portion along a direction generally parallel to the periphery, the method further comprising conveying the inflation gas from the interior portion into the folds to induce the cushion to unfold.

63. A method for protecting an occupant of a vehicle from impact through the use of an airbag module comprising an inflator, a cushion, and a housing, the method comprising:
transmitting an activation signal to trigger production of inflation gas by the inflator, wherein the housing retains the inflator and the cushion;
directing the inflation gas into the cushion to inflate the cushion;
receiving impact of the occupant against the cushion; and
deforming the housing in response to impact of the occupant against the cushion to absorb kinetic energy from the occupant.

64. The method of claim 63, wherein the cushion is positionable within an instrument panel of the vehicle, wherein the airbag module further comprises a cover extending along a periphery of the instrument panel, the method further comprising rupturing the cover to permit the cushion to emerge from within the instrument panel.

65. The method of claim 64, wherein the cover comprises a forward edge and a rearward edge, wherein rupturing the cover comprises:
forming a bulge proximate the forward edge; and
detaching the rearward edge from the instrument panel to permit the cover to open.

66. The method of claim 63, wherein the inflator and the cushion are both positioned proximate the periphery and the inflator is displaced forward of the cushion, wherein directing the inflation gas into the cushion comprises moving the inflation gas rearward.

67. The method of claim 66, wherein the airbag module further comprises a housing positioned to retain the cushion and the inflator, the housing having a generally flat surface oriented generally parallel to the cushion, wherein deforming the housing comprises bending the generally flat surface into the instrument panel in response to pressure of inflation gas within the cushion.

68. The method of claim 66, wherein the housing comprises a diffuser having a generally planar shape oriented generally parallel to the cushion, wherein directing the inflation gas into the cushion comprises moving the inflation gas within the diffuser, along a direction generally parallel to the cushion to reach a plurality of orifices of the diffuser.
